(19) United States
(12) Patent Application Publication
(10) Pub. No.: US 2010/0031185 A1
(43) Pub. Date: Feb. 4, 2010

(54) WEB PAGE PUSH TO NEW WINDOW

(75) Inventors: Jeffrey Kenneth WILSON, Austin, TX (US); Indran NAICK, Cedar Park, TX (US)

Correspondence Address: IBM CORPORATION;INTELLECTUAL PROPERTY LAW, 11501 BURNET ROAD, AUSTIN, TX, 78758, US

(73) Assignee: International Business Machines Corporation, Armonk, NY (US)

(21) Appl. No.: 12/183,255

(22) Filed: Jul. 31, 2008

(51) Int. Cl. G06F 3/048

(52) U.S. Cl. 715/777

(57) ABSTRACT

A method is disclosed by which a user can set aside a tabbed internet browser window having a desired view. By user command the method creates a second tabbed internet browser window displaying the desired view. The user can then be returned to the first tabbed internet browser window displaying a previous view.

### FIELD

The embodiments disclosed herein related to human-computer interaction (HCI) and graphical user interface (GUI) technologies in the management of windows which display internet web page or other content. Embodiments are disclosed in which a graphically displayed window can be set aside to a new window.

### BACKGROUND

It is common for a computer user to launch one or more web pages from a source web page having internet hyperlinks and which is displayed in an internet browser window. Problems exist with currently existing internet browsing, HCI and GUI technology in that it is difficult for a user to make a web page conveniently available for later viewing without interfering with a user's internet searching activities.

In at least one currently available internet browser, if a user desires to provide for a web page view to be available for later viewing, the user is required to select and activate the “back” button, then make a selection to launch a new web page, tab or window, to contain the desired content. Alternatively in this existing technology, the user can activate the “back” button followed by activating a “hot key” as steps to make the content available for later viewing.

In another currently available internet browser, if a user desires to set aside a web page view for later viewing, the user is required to select and activate the “File” functionality followed by activating the “New Tab” functionality which transfers the uniform resource locator (URL) of the currently active page into a “New Tab”. The user is then required to navigate back to the original web page view and then hit the “back” button to its source web page.

Accordingly, the current state of technology regarding internet browsing, HCI and GUT technology contains problems resulting in inefficient and burdensome web page management.

### SUMMARY

A method is disclosed which allows a user to efficiently and easily set aside a tabbed internet browser window having a first view. In one embodiment, the method includes a number of steps including providing a computer system which displays a user viewable data. The method then continues by displaying a first view in a first tabbed internet browser window, in which the first view is generated from a data source having a first view data. The method then continues by receiving a user command to display a second view in the first tabbed internet browser window, said second view generated from a data source having a second view data. The method then continues by copying the first view data into a first screen buffer. The method then continues by displaying the second view in the first tabbed internet browser window. The method then continues by receiving a user command to load the second view into a second tabbed internet browser window. The method then continues by storing the second view data in a second screen buffer. The method then continues by establishing the second tabbed internet browser window in response to said user command. The method then continues by loading the second view data from the second screen buffer to display the second view in the second tabbed internet browser window. The method then continues by accessing the first screen buffer having the first view data. The method then continues by loading the first view data from the first screen buffer into the first tabbed internet browser window to display the first view in the first tabbed internet browser window replacing the second view present in the first tabbed internet browser window. The method then continues by displaying the first view in the first tabbed internet browser window. Finally, the method then continues by providing a user access to the second tabbed internet browser window having said second view.

### DESCRIPTION OF THE FIGURES

FIG. 1 is a functional block diagram of a computer system which performs role based prioritization of computer processes.

FIG. 2 is an example flow diagram of an example embodiment for the sequence of steps carried out by the computer system of FIG. 1.

FIG. 3A illustrates a first window having a first view.

FIG. 3B illustrates a first window having a second view.

FIG. 3C illustrates a first window receiving a user command.

FIG. 3D illustrates a first window having a first view and a second window having a second view.

FIG. 4A illustrates a first tabbed internet browser window having a first view.

FIG. 4B illustrates a first tabbed internet browser window having a second view.

FIG. 4C illustrates a first tabbed internet browser window receiving a user command.

FIG. 4D illustrates a first tabbed internet browser window having a first view and a second tabbed internet browser window having a second view. In this depiction, the first tabbed internet browser window having the first view is selected for viewing.

FIG. 4E illustrates a first tabbed internet browser window having a first view and a second tabbed internet browser window having a second view. In this depiction, the second tabbed internet browser window having the second view is selected for viewing.

### DISCUSSION OF EXAMPLE EMBODIMENTS OF THE INVENTION

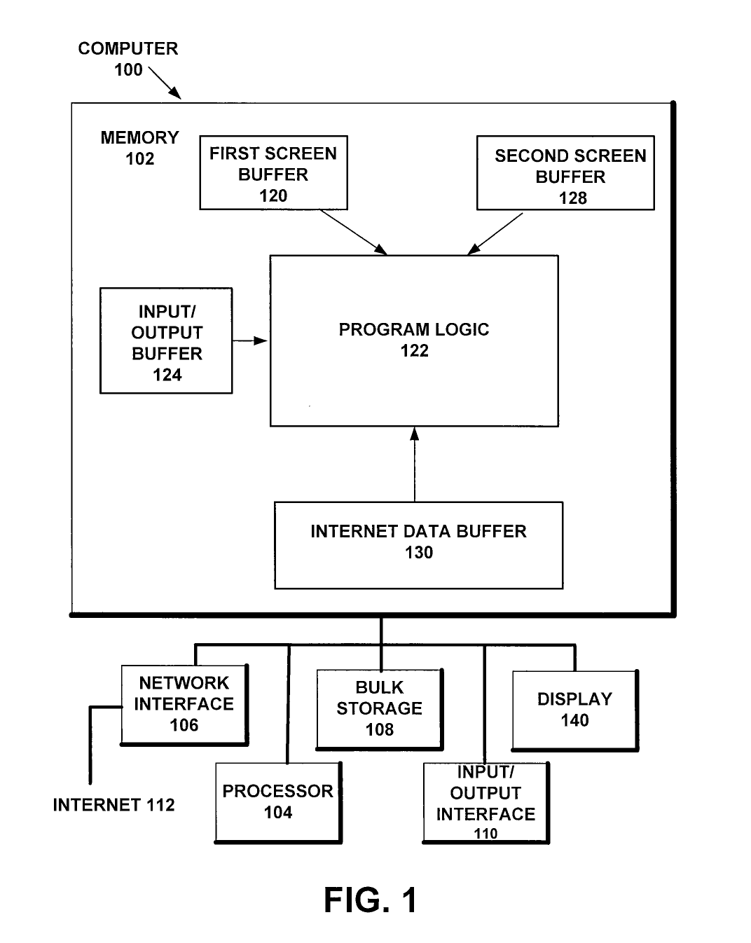

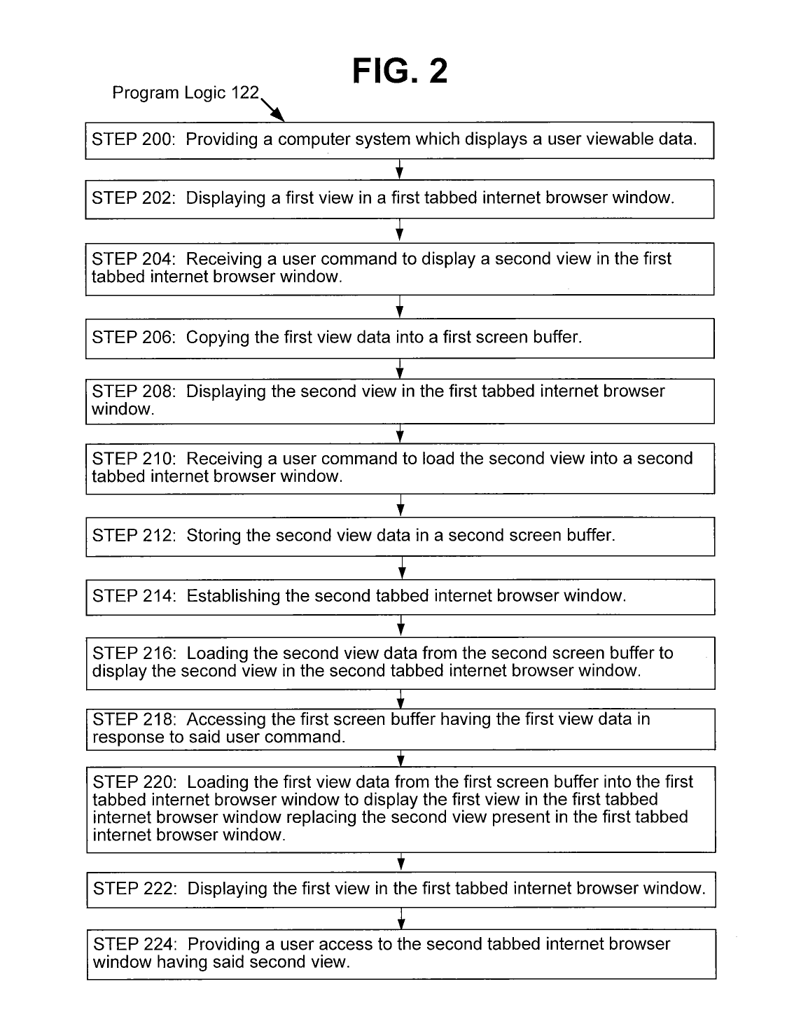

FIG. 1 is a functional block diagram of a computer system which performs role based prioritization of computer processes. The computer system includes, a computer 100, a memory 102, processor 104, bulk storage 108, and input/output interface 110 connecting the computer to devices and computer systems such as, but not limited to, a keyboard, a mouse, communications systems and networks, other processors, and other user input and output devices. The computer system also includes a network interface 106 which interfaces at least with internet 112. The computer system also includes a display 140 which displays a user viewable data. Additionally, the computer system includes an input/output buffer 124 and an internet data buffer 130. The computer system includes a first screen buffer 120 and a second screen buffer 128. The number, type and configuration of hardware and memory are not limited. The computer system also includes program logic 122 which is described in FIG. 2.

FIG. 2 is an example flow diagram of an example embodiment for the sequence of steps which can be carried out by the computer system of FIG. 1. FIG. 2 illustrates an embodiment of program logic 122 as described below.

Step 200 is providing a computer system which displays a user viewable data.

Step 202 is displaying a first view in a first tabbed internet browser window.

Step 204 is receiving a user command to display a second view in the first tabbed internet browser window.

Step 206 is copying the first view data into a first screen buffer.

Step 208 is displaying the second view in the first tabbed internet browser window.

Step 210 is receiving a user command to load the second view into a second tabbed internet browser window.

Step 212 is storing the second view data in a second screen buffer.

Step 214 is establishing the second tabbed internet browser window in response to said user command.

Step 216 is loading the second view data from the second screen buffer to display the second view in the second tabbed internet browser window.

Step 218 is accessing the first screen buffer having the first view data.

Step 220 is loading the first view data from the first screen buffer into the first tabbed internet browser window to display the first view in the first tabbed internet browser window replacing the second view present in the first tabbed internet browser window.

Step 222 is displaying the first view in the first tabbed internet browser window.

Step 224 is providing a user access to the second tabbed internet browser window having said second view.

In this manner a second tabbed internet browser window is created and a first tabbed internet browser window is set aside.

### EXAMPLES

This disclosure contains a number of terms which shall be broadly construed. As used herein, the term “window” is to be broadly construed. In addition to its ordinary and customary meaning, the term “window” includes within its scope a GUI which comprises a visual area which can contain a data and/or can contain a user interface to a computer process. Optionally, a window can function in input/output processes. A window can comprise an array representing all or part of a visual display and can include a portion of a display screen which can contain a document, image, view or message. A window can be a separate visual entity from other elements of the display, or can be related to one or more visual entities. As a non-limiting example, in window-based programs, a window can be a visual display area having its own boundary. In another non-limiting example, a visual display can be divided into a plurality of windows with each window of the plurality having its own boundaries. As additional non-limiting examples, a window can comprise a visual area such as a tile, a pop-up, a frame, a pane, a sheet and/or a geometric shape.

A “tabbed internet browser window” is any type of window having, relating to, or associated with, any type of tab. As used herein the terms “tab” and “tabbed” are to be broadly construed. In addition to its ordinary and customary meaning, the term “tab” broadly includes a graphical object associated with a window, relating to a window, part of a window, or as a separate object, which can be a navigational and/or a visual display element by which a user can select a view, window, control, process, interface, element, command or document. As used herein, the term “tabbed” means anything which has a tab, a tab feature, a tab-like visual element, or is associated with a tab.

As used herein the term “view” is to be broadly construed. In addition to its ordinary and customary meaning, the term “view” includes within its scope any display of data. As a non-limiting example, a view can comprise a display of data on a computer screen, as well as a display of data within or associated with a window. The term view also encompasses a display of data of, or associated with, a displayed web page.

As used herein, the term “set aside” is to be broadly construed. In addition to its ordinary and customary meaning, the term “set aside” includes any process by which a window is made available apart or differently from its original state and/or which allows a user to access a window. Additionally, to “set aside” encompasses the creation of a new window by which the contents of an original window can be available to a user. Also, to “set aside” encompasses the creation of a second window making available and/or allowing access to all, or part, of the contents of a first window. Further, “set aside” encompasses any instance in which a content, or a view, of a window is placed in a state, a status, a window, a visual element, or a construct, in which a user can interface with that content apart from the previous display of such content.

As used herein, the term “push” is to be broadly construed and encompasses a user command, or instruction, to set aside a window. In addition to its ordinary and customary meaning, the term “push” is a command used analogously with the a command to “set aside”, drag, duplicate, copy, provide, reserve, hold, transform and/or make a new window to provide access to previously viewed data. Broadly, the commands “push” and “set aside” respectively encompass a method, or process, by which a second window is created or transformed to provide all, or part, of the content (or view) of a first window.

Provided herein are example embodiments to set aside a first window, as well as to set aside a first tabbed internet browser window. There is no limit to the number of windows which can function as source windows which are to be set aside. There is also no limit to the number of windows which can be set aside. In one embodiment, a method is provided for scanning multiple pages efficiently where a desired page is set aside, or pushed, into a new window and by which the window from which the set aside content was taken is refreshed to display the page which was the source of the set aside content (i.e., content which was set aside to the new window).

The input by which the user can set aside, or push, a window (or tabbed internet browser window) can be a single command, or it can comprise more than one command. The command can optionally include a push by a mouse interface, a drag by a mouse interface, a mouse click, a keyboard-based command, a touch-screen-based command, a light-device-based command, a voice-based command, or other user command received by an input/output device or other interface. The commands, or command sequence, by which a window is set aside, or pushed, into a new window is not limited.

### Example 1

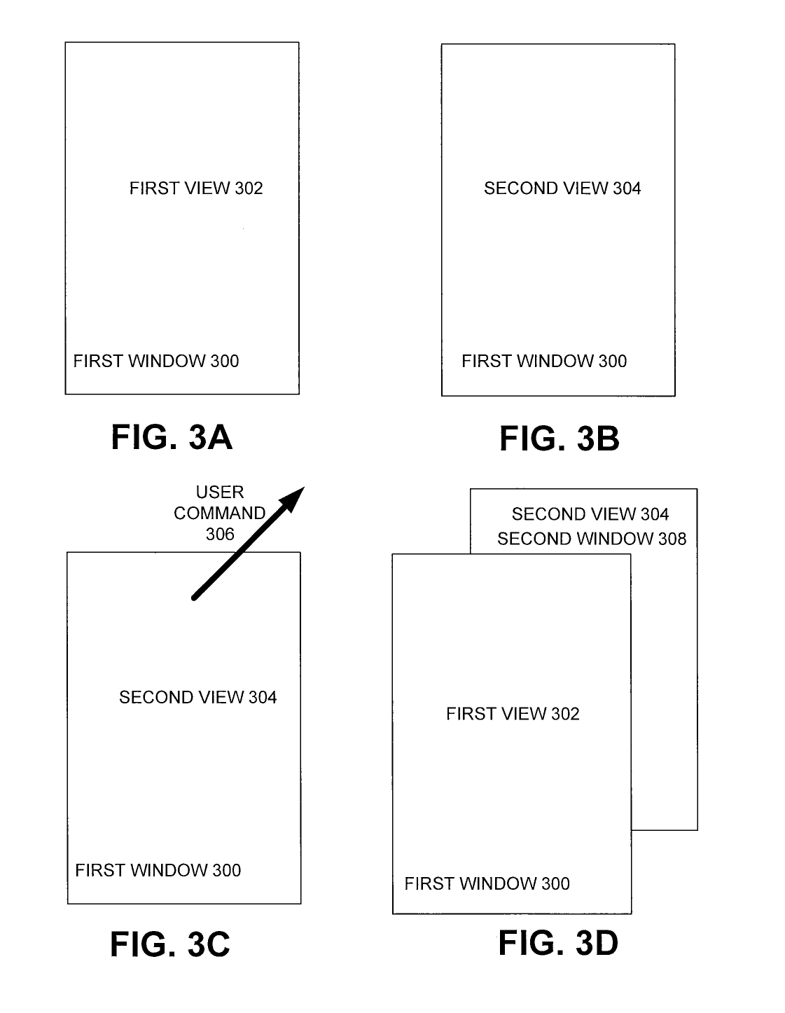

FIGS. 3A-3D illustrate an embodiment in which a first window 300 displaying a second view 304 is set aside (pushed) into a second window 308 which displays the second view 304. The first window 300 is refreshed to again display the first view 302 and the user can interface with the first window 300 and the contents of first view 302. The user can also select the second window 308 and can interface with the second window 308 and its contents in second view 304.

FIG. 3A illustrates a first window 300, which can be of an internet browser or other program which can display data on a device, e.g. but not limited to, a computer screen, smart phone, cell phone, PDA or other device. This first window 300 can contain content from an internet or other data source which is displayed to the user as a first view 302. There is no limitation on the number of windows which can be opened. The first window 300 is considered herein to be the window which the user commands to be to set aside, or pushed, into a new window.

As illustrated in FIG. 3B, the user can open up a second view 304 in the first window 300. The second view 304 can optionally be uploaded from an internet, a buffer or other data source. Optionally, when a command is received to open a second view 304, the data of the first view 302 can be stored in a memory buffer (e.g., FIG. 1, first screen buffer 120).

As illustrated in FIG. 3C, the user can provide a user command 306 to set aside (push) the first window 300 into a second window 308. Alternatively, the command can be to set aside (push) the second view 304 into a second window 308. Optionally, the second view 304 can be set aside in a buffer for uploading in the second window 308 (e.g., from FIG. 1, second screen buffer 128), or the second view can be once again accessed from its original source for display in the second window 308.

As illustrated in FIG. 3D, upon receipt of user command 306 a new second window 308 is created and second view 304 is uploaded from a data source and displayed in second window 308 (e.g., from FIG. 1, second screen buffer 128, or e.g. from internet data buffer 130). The first window 300 is maintained and is updated by uploading first view data from a data source to display the first view 302 replacing second view 304 (e.g., FIG. 1, first screen buffer 120, or e.g. from internet data buffer 130).

In FIG. 3D the new second window 308 is optionally shown as nested behind first window 300. There is no limitation to the graphical arrangement of the first window and the second window which has been set aside. The first window 300 and the second window 308 can be arranged in a nested fashion as illustrated in FIG. 3D, or can be adjacent to one another, or can partially overlap, or can be displayed on separate screens, or one or both windows can be minimized, or can be displayed in any desired arrangement.

### Example 2

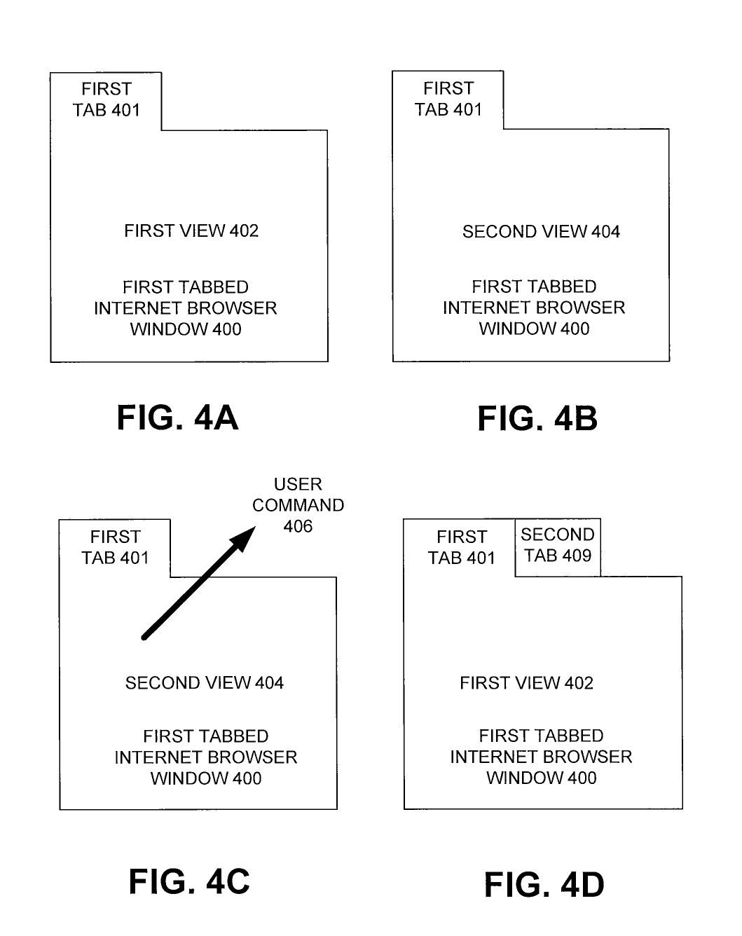

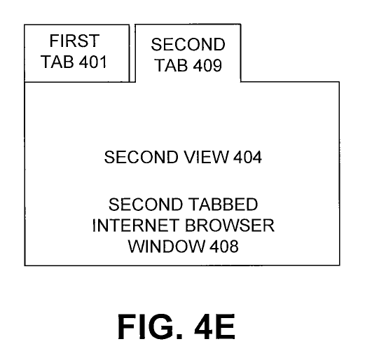

FIGS. 4A-4E illustrate an embodiment in which a first tabbed internet browser window 400 displaying a second view 404 is set aside (pushed) into a second tabbed internet browser window 408 which displays the second view 404. The first tabbed internet browser window 400 is refreshed to again display the first view 402 and the user can interface with the first tabbed internet browser window 400 and the contents of first view 402. The user can also select the second tabbed internet browser window 408 and can interface with the second tabbed internet browser window 408 and its contents in second view 404.

FIG. 4A illustrates a first tabbed internet browser window 400 which can be of an internet browser or other program which can display data on a device, e.g. but not limited to, computer screen, smart phone, cell phone, PDA or other device. First tabbed internet browser window has first tab 401. This first tabbed internet browser window 400 can contain content from the internet or other source which is displayed to the user as a first view 402. There is no limitation on the number of tabbed internet browser windows which can be opened. The first tabbed internet browser window 400, is considered herein to be the window which the user commands to be to set aside, or pushed, into a new tabbed internet browser window.

As illustrated in FIG. 4B, the user can open up a second view 404 in the first tabbed internet browser window 400. The second view 404 can be uploaded from the internet, a buffer or other data source. Optionally, when a command is received to open a second view 404, the data of the first view 402 can be stored in a memory buffer (e.g., FIG. 1, first screen buffer 120).

As illustrated in FIG. 4C, the user can provide a user command 406 to set aside (push) the first tabbed internet browser window 400 into a second tabbed internet browser window 408. Alternatively, the command can be to set aside (push) the second view 404 into a second tabbed internet browser window 408. Optionally, the second view 404 can be set aside in a buffer for uploading in the second window 408 (e.g., from FIG. 1, second screen buffer 128), or the second view can be once again accessed from its original source for display in the second window 408.

As illustrated in FIGS. 4D and 4E, upon receipt of user command 406 a new second tabbed internet browser window 408 is created having second tab 409. Second view 404 is uploaded from a data source and displayed in second tabbed internet browser window 408 (e.g., from FIG. 1, second screen buffer 128, or e.g. from internet data buffer 130). The first tabbed internet browser window 400 is maintained and is updated by uploading first view data from a data source to display the first view 402 replacing second view 404 (e.g., FIG. 1, first screen buffer 120, or e.g. from internet data buffer 130).

In FIG. 4D, the new second tabbed internet browser window 408 having second tab 409 is illustrated to be at least in-part displayed behind first tabbed internet browser window 400 having first view 402. Second tab 409 of the second tabbed internet browser window 408 is illustrated adjacent to first tab 401 of first tabbed internet browser window 400.

FIG. 4E illustrates a configuration having second tabbed internet browser window 408 having second view 404 displayed in front of at least a portion of the first tabbed internet browser window 400 having first tab 401. First tab 401 of first tabbed internet browser window 400 is illustrated adjacent to second tab 409 of the second tabbed internet browser window 408 containing second view 404.

There is no limitation to the graphical arrangement of the first tabbed internet browser window and the set-aside second tabbed internet browser window. The first tabbed internet browser window 400 and the second tabbed internet browser window 408 can be arranged in a nested, or overlaid, fashion as illustrated in FIG. 4D, or can be placed adjacent to one another, or can partially overlap, or can be displayed on separate screens, or one or both tabbed internet browser windows could be minimized, or configured in any desired arrangement.

### Example 3

In one embodiment, a user can employ an internet search engine (as a non-limiting example, Google) to conduct a search which can return search results constituting a first view in a first window. The first view can contain a hyperlink. A user can select the hyperlink and cause the first view to be replaced with the contents of the linked URL constituting a second view. The user can command to set aside, or push, the first window into a new second window. The second view is then displayed in the new second window. Then, the first window can be updated to again display the first view. The user can continue to interface with the first window which again displays the first view. This process can occur without limit to the nature of the optional buffering, storing or accessing, or internet uploading of the data of the first view and second view.

Using the description provided herein, the embodiments can be implemented as a machine, process, or article of manufacture by using standard programming and/or engineering techniques to produce programming software, firmware, hardware or any combination thereof.

Any resulting program(s), having computer-readable program code, can be embodied on one or more computer-usable media such as resident memory devices, smart cards or other removable memory devices, or transmitting devices, thereby making a computer program product or article of manufacture according to the embodiments.

Although specific example embodiments have been disclosed, a person skilled in the art will understand that changes can be made to the specific example embodiments without departing from the spirit and scope of the invention.

1. A method, comprising the steps of:
providing a computer system which displays a user viewable data;
displaying a first view in a first tabbed internet browser window, said first view generated from a data source having a first view data;
receiving a user command to display a second view in the first tabbed internet browser window, said second view generated from a data source having a second view data;
copying the first view data into a first screen buffer;
displaying the second view in the first tabbed internet browser window;
receiving a user command to load the second view into a second tabbed internet browser window;
storing the second view data in a second screen buffer;
establishing the second tabbed internet browser window in response to said user command;
loading the second view data from the second screen buffer to display the second view in the second tabbed internet browser window;
accessing the first screen buffer having the first view data;
loading the first view data from the first screen buffer into the first tabbed internet browser window to display the first view in the first tabbed internet browser window without additional user commands;
displaying the first view in the first tabbed internet browser window; and
providing a user access to the second tabbed internet browser window having said second view.
